(19) United States
(12) Patent Application Publication
(10) Pub. No.: US 2005/0225587 A1
(43) Pub. Date: Oct. 13, 2005

(54) Method and imaging device for adjusting a printing head

(76) Inventors: Uwe Hoffmann, Kiel (DE); Patrick Metzler, St. Wendel (DE); Karlheinz Walter Peter, Molfsee (DE); Holger Runkowske, Fahren (DE); Christopher Liston, Rochester, NY (US)

Correspondence Address: Lawrence P. Kessler;Patent Department, NexPress Solutions LLC, 1447 St. Paul Street, Rochester, NY, 14653-7103, US

(21) Appl. No.: 10/822,323

(22) Filed: Apr. 12, 2004

(51) Int. Cl. B41J 29/393

(52) U.S. Cl. 347/19

(57) ABSTRACT

Positioning a printing head of a printing press in which marks are applied on a support that is detected by sensors and as a consequence, the printing head is adjusted, the marks being applied on two opposite sides of the support that are detected by two correspondingly arranged sensors, and the printing head is oriented in response to the results of the two sensors.

### FIELD OF THE INVENTION

The invention relates to positioning a printing head in a printing press by sensing marks on opposite sides of a print material support.

### BACKGROUND OF THE INVENTION

In the field of printing technology, positionally correct overprinting of a print image on a print material is one of the most important tasks, and is critical in determining the print quality. Positionally correct overprinting is influenced, i.e., by the position of imaging devices that produce an image, which is overprinted subsequently on a print material. The imaging device includes at least one printing head, which applies the image indirectly or directly on the print material. For example, the printing head can directly apply ink or toner on the print material, for example, using the inkjet method, or, can first apply an electrostatic latent image which is then subsequently applied with toner and made visible using the electrophotographic method. The printing head can be applied directly on the print material or can write on an imaging cylinder which then, in turn, transfers a print image directly or indirectly on the print material. The position of the printing head of the imaging device thus has major importance in the positionally correct application of the print image on the print material. The position of the printing head can change during operation due to mechanical and thermal influences.

### SUMMARY OF THE INVENTION

The objective of the invention is to ensure positionally correct printing in a printing press. In order for positioning a printing head of a printing press in which marks are applied on a support that is detected by sensors and as a consequence, the printing head is adjusted, the marks being applied on two opposite sides of the support that are detected by two correspondingly arranged sensors, and the printing head is oriented in response to the results of the two sensors.

### BRIEF DESCRIPTION OF THE INVENTION

In the detailed description of the preferred embodiment of the invention presented below, reference is made to the accompanying drawings, in which:

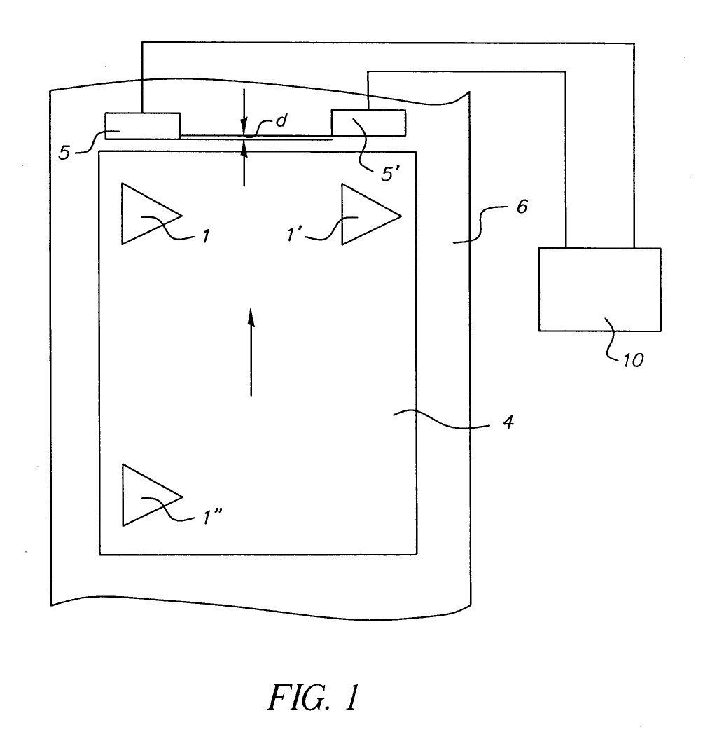

FIG. 1 is a schematic top view of a section of a transport medium with a calibration sheet with marks for positioning sensors; and

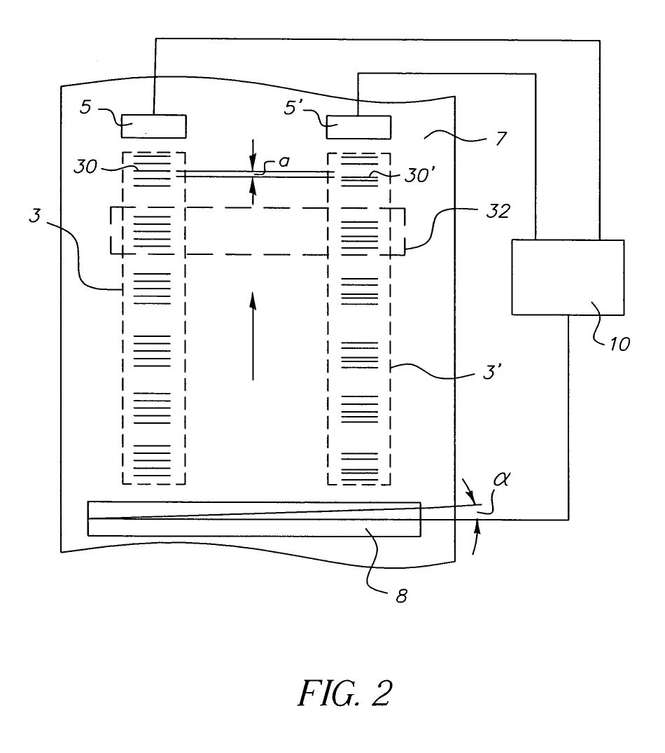

FIG. 2 is a schematic top view of a section of the transport medium with marks applied on it for positioning the printing head.

### DETAILED DESCRIPTION OF THE INVENTION

FIG. 1 shows a schematic top view of a section of an endless conveyor belt 6 of a printing press for conveying print material through the printing press. The conveyor belt 6, is tensioned by rollers (not shown). On the conveyor belt 6, a calibration sheet 4 of print material is transported in the direction of the arrow through the printing press. The calibration sheet 4 is provided with triangular marks 1, 1′, 1″; two triangular marks 1, 1′ are located close to the front edge of the calibration sheet 4; and a further triangular mark 1″ is located adjacent to the rear edge of the calibration sheet 4. Here, the triangular marks 1, 1′, 1″ are stamped into the calibration sheet 4 so that recesses arise on the calibration sheet 4.

The calibration sheet 4 is used to calibrate two sensors 5, 5′, which are arranged above the conveyor belt 6 with the calibration sheet 4. The positions of the triangular marks 1, 1′, 1″ are extremely precise with respect to the calibration sheet 4. The sensors 5, 5′ detect the triangular marks 1, 1′, 1″, and transmit corresponding sensor signals to a control device 10 in which pulses are counted and stored.

The detection of a first edge of a triangular mark 1 by a sensor 5 starts a pulse, which is counted, and is halted when the second edge of the same mark 1 is detected by the same sensor 5. This procedure is performed correspondingly with the remaining triangular marks 1′, 1″. The two detected edges of the triangular marks 1, 1′, 1″ are, in this example, in each case the sides of an isosceles triangle whose base sides are oriented in each case parallel to the lateral faces of the calibration sheet 4.

The counted pulses when detecting the marks 1, 1′, 1″, are compared in the control device 10. Since the marks 1, 1′, 1″ are stamped in on the calibration sheet 4 in an extremely precise manner, it is possible to determine the position of the two sensors 5, 5′ with respect to one another in the direction of transport using the triangular marks 1, 1′, 1″. In other words, in this manner, an undesired offset of the sensors 5, 5′ can be determined, a faulty positioning of the sensors 5, 5′ with respect to one another which are located ideally exactly at a height with respect to the transport direction of the calibration sheet 4.

With the above calibration, a faulty positioning of the sensors 5, 5′ can be determined which is represented in FIG. 1 by a path distance d. In this connection, the values measured by the sensors 5, 5′ at the marks 1, 1′, 1″ are compared, particularly the values of the mark 1 with the values of the mark 1′, which are ideally equal since the marks 1, 1′, 1″ are identical and the marks 1, 1′ are located at the same height on the calibration sheet 4. If the values determined by the sensors 5, 5′ of the marks 1, 1′ are not equal, then it is concluded that there is an offset of the sensors 5, 5′ with respect to one another which can be determined quantitatively based on the values.

The sensors 5, 5′ are displaced according to FIG. 1 with respect to one another with reference to the transport direction in the longitudinal direction with respect to the conveyor belt 6 by a path distance d; they are undesirably not at the same height with reference to the transport direction. The calibration sheet 4 with the marks 1, 1′, 1″ serves to determine this displacement, a correction of the displacement of the sensors 5, 5′ with respect to one another being performed subsequently. The displacement of the sensors 5, 5′ with respect to one another can be compensated in the control device 10 by incorporating the number of pulses, which correspond to the path distance d in the following measurements.

During subsequent measurements, the determined value is added to each detected value of the sensor 5′ which lies in the transport direction by the path distance d behind the sensor 5, which value indicates the number of pulses that were counted by the pulse counter in the control device 10 for the path distance d of the offset of the sensor 5′ with respect to the sensor 5. In this manner, the calibration of the position of the sensors 5, 5′ with respect to one another is achieved. Mechanical and thermal tolerances of the positions of the sensors 5, 5′ are compensated.

Moreover, using the triangular marks 1, 1′, 1″ on the calibration sheet 4, the orientation of the calibration sheet 4 on the conveyor belt 6 can be determined in terms of the angle, the angular orientation of the calibration sheet 4. The angular displacement, an undesired displacement with reference to the correct angular orientation at which the lateral edges of the calibration sheet 4 run in parallel to the lateral edges of the conveyor belt 6, designates a rotation of the calibration sheet 4 around its center point. The angular displacement of the calibration sheet 4 is determined using the marks 1, 1′ arranged behind one another with respect to the transport direction.

The possible angular displacement of the calibration sheet 4 on the conveyor belt 6 is taken into account in determining the offset of the sensors 5, 5′ with respect to one another by the path distance d in the control device 10. This is possible since an angular displacement of the calibration sheet 4 can be uniquely associated with the three values of the separations of the sides of the triangular marks 1, 1′, 1″ detected by the sensors 5, 5′. A value is supplied by measuring the separation of the sides of the mark 1 with respect to one another, a second value is supplied by measuring the separation of the legs of the mark 1′ with respect to one another, and a third value is supplied by measuring the separation of the legs of the mark 1″ with respect to one another. These three values are associated in the control device 10 with an angular displacement of the calibration sheet 4. Even if the calibration sheet 4 has a displacement perpendicular or transverse to the transport direction (“cross track”), the angular displacement can be determined since, in this case, the three values of the three marks 1, 1′, 1″ change in the same manner and different comparison values are stored in the control device 10 with which angular displacements of the calibration sheet 4 with different displacements transverse to the transport direction are associated.

In this manner, angular displacements are determined if the calibration sheet 4 is displaced additionally transverse to the transport direction. By taking into account a possible angular displacement of the calibration sheet 4, the path distance d, the undesired separation of the sensors 5, 5′ with respect to one another, can be computed in the control device 10. Thus, the faulty orientation of the sensors 5, 5′ with respect to one another can be clearly computed even if the calibration sheet 4 on the conveyor belt 6 has an angular displacement and/or a displacement transverse to the transport direction.

FIG. 2 shows a schematic top view of a support 7 which can accommodate an image. Here, the support 7 is, in an exemplary manner, a conveyor belt 6 of a printing press; moreover, the support 7 can be seen as an imaging cylinder in an electrophotographic printing press. Above the support 7, a printing head 8 is arranged which applies an image on the support 7. In the demonstrated example, the printing head 8 applies marks 3, 3′ on a conveyor belt as support 7. In the other case, the printing head 8 applies latent electrostatic bars or lines which come together to marks 3, 3′ on an imaging cylinder; the lines are provided subsequently with toner so that a visible image of lines arises, which is transferred directly or indirectly to an intermediate cylinder on a conveyor belt 6 or a print material.

In this example, the marks 3, 3′ are composed of six bars or lines; two lines serve as reference lines for the remaining four lines which present, in each case, one color, and are applied by different print modules or units. The two first reference lines are black; the following four lines are cyan, magenta, yellow, and black. The marks 3 are applied near the right side and the marks 3′ are applied near to the left side of the support 7. For the sake of clarity, the marks 3, 3′ are surrounded by dashed lines.

The marks are used customarily to sense the proper registration and/or registration mark stability of a printed image in a calibration procedure in the printing press prior to the printing operation. After the positioning of the sensors 5, 5′ with respect to one another is calibrated, as was described for FIG. 1, the sensors 5, 5′ now detect the marks 3, 3′ on the support, in this example, a conveyor belt, in order to sense whether the marks 3, 3′ are located at the desired location on the support 7. For this purpose, the sensors 5, 5′ detect in each case the lines of the marks 3, 3′; the sensor 5 on the left side of the support 7 detects the lines of the marks 3 on the left side of the support 7; and the sensor 5′ on the right side of the support 7 detects the lines of the marks 3′ on the right side of the support 7.

In the present embodiment, printing heads 8 (a single printing head 8 is shown) apply in each case a colored line on the support 7; a printing head 8 applies in each case the two reference lines, i.e., this printing head 8 applies three lines per mark 3, 3′. The sensors 5, 5′ detect the lines in each case with respect to the first two reference lines, and transfer corresponding sensor signals to the control device 10. Per colored line, the four lines following the two reference lines, at least one pulse from a reference line to the relevant line of the mark 3, 3′ is counted. In the control device 10, at least four pulse values are then present for each mark 3, 3′; at least one pulse value is painted for each colored line.

The pulse values for each colored line of the marks 3 on the left side of the support 7, are compared in the control device 10 with the corresponding pulse values of the marks 3′ on the right side of the support 7, e.g., the pulse value measured by the sensor 5 and counted for the line with the color cyan of the mark 3 is compared with the pulse value measured by the sensor 5′ and counted for the line with the color cyan of the mark 3′, which is located at about the same height as the mark 3. By way of this comparison, it is possible to sense whether the corresponding lines of the marks 3 on the one hand, and of the marks 3′ on the other hand are located at the same height, with respect to the transport direction. If the corresponding lines for the individual colors are located at the same height on the support 7, with respect to the transport direction, then it is determined that in the control device 10, the respective printing head 8 has a desired positionally correct orientation or position transverse to the support 7 and to the transport direction of the support 7.

For each individual line of a mark 3, 3′, which are applied in each case by a printing head 8 this comparison is performed. In this manner, for each printing head 8, in this example, four printing heads 8, for black, cyan, magenta, and yellow, the position transverse to the transport direction of the support 7 can be determined. An undesired faulty orientation of each individual printing head 8 is determined in the control device 10. The faulty orientation can have different causes, such as mechanical or thermal causes, which occur during installation or operation of the printing press.

The positions of the individual printing heads 8 are shown on a display of the control device 10, and can possibly be corrected by the operator of the printing press using adjustment mechanisms for each individual printing head 8. In FIG. 2, a faulty position of the printing head 8 is shown, the printing head 8 being tilted by an angle α with respect to its ideal position transverse to the support 7; the printing head 8 is improperly oriented on its right side, contrary to the transport direction of the support 7. The faulty orientation of the printing head 8 is caused, for example, by mechanical or thermal influences that occur during installation or operation of the printing press.

The faulty position by the angle α, a tilting of the printing head 8 on one side, leads to the line 30′ applied by the printing head 8 on the support 7 of the right mark 5′ being arranged at an offset to the corresponding line 30 applied by the same printing head 8. The lines 30, 30′ are, for example, lines having the color cyan that were applied by the printing head 8, which in the described calibration procedure produces lines with the color cyan and prints the color cyan during the printing operation as a component color of the overall colored image. Here, the lines 30, 30′ are offset by a path a with respect to one another, caused by the faulty position of the printing head 8. The corresponding lines applied by the printing head 8 of the remaining marks 3′ on the right side of the support 7, in each case the third line of each mark 3′, are displaced correspondingly.

The remaining printing heads (not shown) are correctly oriented; thus, the remaining lines of the marks 3, 3′ are applied at the error-free position. A comparison of the pulse values measured by the sensors 5, 5′ is made between corresponding lines of the marks 5 to the marks 5′, and understandably, only corresponding lines of associated marks 5, 5′ are being compared. For example, two associated marks 5, 5′ are surrounded by a dashed frame 32 whose six lines are applied in the ideal case, without a faulty position of a printing head, simultaneously, each line of a color at the same time, so that the six lines of the mark 5 lie in each case at the same height as the six lines of the mark 5′ in the dashed frame 32. With the aid of the described imaging device and the method, positions of the printing heads 8 can be determined in a calibration procedure and faulty positions of the printing heads 8 can be corrected with the print quality being ensured through a suitable position of the printing heads 8. Here, the printing head 8 is swiveled or lifted on one side in a manner so that it is oriented perpendicularly to the support 7, and the angle α diminishes to zero.

The invention has been described in detail with particular reference to certain preferred embodiments thereof, but it will be understood that variations and modifications can be effected within the spirit and scope of the invention.

1. A method for positioning a printing head (8) of a printing press, comprising the steps of: applying marks (3, 3′) on a support (7) wherein the marks (3) are applied on two opposite side of the support (7); detecting said marks (3, 3′) respectively by two correspondingly arranged sensors (5, 5′); and, as a consequence adjusting the printing head (8), so as to be oriented in response to the results of the two sensors (5, 5′).

2. The method according to claim 1, wherein the printing head (8) is oriented so that one side of the printing head (8) is swiveled in the transport direction of the support (7) for ensuring the proper registration and/or registration mark stability.

3. The method according to claim 2, wherein on each side of the support (7), a plurality of marks (3, 3′) with different colors is applied, the sensors (5, 5′) detect the individual marks (3, 3′) of each color and the printing heads (8) associated with the different colors are oriented in response to the results in terms of the individual marks (3, 3′) of each color.

4. The method according to claim 1, wherein a calibration sheet (4) of print material is provided with triangular marks (1, 1′, 1″) that are detected by the sensors (5, 5′) and the position of the sensors are used (5, 5′) with respect to one another in the transport direction of the calibration sheet (4).

5. An imaging device for a printing press comprising: a printing head (8) which can swivel in the transport direction of a support (7) for ensuring the proper registration and/or registration mark stability, using marks (3, 3′) applied on two opposite sides of the support (7).
